(19) United States
(12) Patent Application Publication
(10) Pub. No.: US 2016/0379124 A1
(43) Pub. Date: Dec. 29, 2016

(54) SYSTEM AND METHOD OF PROACTIVE SELF-CARE FOR ELECTRONIC DEVICES

(71) Applicant: CrowdCare Corporation, Richmond Hill (CA)

(72) Inventors: Jeffrey Brunet, Aurora (CA); Yousuf Chowdhary, Maple (CA); Ian Collins, Markham (CA); Karen Chan, Richmond Hill (CA)

(21) Appl. No.: 15/192,929

(22) Filed: Jun. 24, 2016

Related U.S. Application Data
(60) Provisional application No. 62/185,130, filed on Jun. 26, 2015.

(51) Int. Cl. G06N 5/04; G06F 17/27; G06Q 30/00

(52) U.S. Cl. CPC G06N 5/047; G06Q 30/016; G06F 17/2705

(57) ABSTRACT

A method is provided for creating pattern-problem pairs for proactive diagnosis of device issues. A plurality of problem reports are received from problem devices, each having parameters associated with a device profile. The problem reports are parsed to standardize and normalize terms. The parsed problem reports are analyzed to identify common problems in a set of such problem devices where there is a common set of parameters in a pattern. If the frequency of the problems in the set of devices exceeds a threshold, the parsed problem is associated with the pattern for future proactive diagnosis of a target device having the pattern, even without a problem report from the target device. A method of proactively diagnosing a potential problem on a device using such pattern-problem pairs is also provided.

### CROSS-REFERENCE TO RELATED PATENT APPLICATION

This application is a U.S. Non-Provisional application of U.S. Provisional Application No. 62/185,130, filed Jun. 26, 2015, the full disclosures of which are incorporated herein by reference in its entirety.

### FIELD OF INVENTION

The invention in general relates to customer care systems for electronic devices and in particular relates to self-care for such devices.

### BACKGROUND OF THE INVENTION

Product development and production cycles for electronic devices are increasingly under pressure and are getting shorter as manufacturers try to come up with new devices in order to gain market share. A shortened development cycle means less time is spent testing the product and many faults or flaws are discovered after the product has already been launched and millions of devices are already in use by consumers all over the world.

This situation is only getting worse with the passage of time as devices become more powerful and capable of handling more sophisticated tasks; and is compounded with the complexity that arises from having many different types of apps that can be installed on these devices, each with its own settings. Thus many scenarios cannot be tested in a lab or predicted in advance, but are only discovered after the launch of a device. This results in increased support costs, increased call handling times, complex diagnostic processes and overall frustration for the customer base.

Current methods of gathering and obtaining device information required for diagnostics are manual and therefore complex, time-consuming and prone to human errors. In the course of a customer care session for a device, a CSR (Customer Service Representative) must undertake the extensive and time-consuming task of asking the consumer complex questions pertaining to the customer's devices for problem diagnosis. This requires CSRs to be experts on many types of devices and their applications, and also requires users to spend increased time on the telephone to receive support for their applications.

Self-care systems exist, whereby information is provided to the consumers and they can use the information to resolve some basic issues themselves, thus helping reduce some of the costs. Such systems lack automation and the consumer is required to sift through massive amounts of data manually to get to the relevant information. Such systems can also quickly become outdated, such as static lists of “frequently asked questions”. While such central knowledge-bases may offer limited help to consumers, they can also become a single point of failure.

A consumer using self-care is required to be vigilant and take an ongoing responsibility of managing and maintaining the electronic device. The consumer also has to react after the problem occurs, which in some cases may be too late resulting in escalation and service level deterioration.

It would be desirable to have a proactive self-care system wherein solutions to unresolved device issues could be sent directly to consumers even before they experience the issue, avoiding calls to the customer service department altogether. Having such a system would reduce expense and increase the overall efficiency of customer care business operations, as it takes fewer customer care resources to support the customer base.

### SUMMARY

Broadly speaking, the present invention provides a method and a system of proactive self-care wherein solutions/remedies regarding device issues are sent directly to consumers even before an issue is experienced, thus proactively reducing the number of calls to the customer service department.

If a pattern-problem pair exists in an electronic device (such as a mobile device or smartphone), and a device profile exhibits the pattern from the pattern-problem pair, then the system can assume that the device will also experience the problem associated with the pattern-problem pair.

In order to diagnose, a device profile is acquired from a mobile device. There may be an app that enables the acquisition of device profile data from the device by querying its settings. The device parameters information may be gathered from the device in real time, or the information may have been cached earlier.

The device profile is analyzed and related data is gathered from the device. A rules engine may be used for analyzing the device profile. The rules engine may be hosted on a remote server and the device may connect to the remote server over a network e.g. over internet.

The device profile may be compared with a database of pattern-problem pairs (combinations). The pattern-problem pairs (combinations) may be derived by analyzing a large set of device profiles and the problems originating from and associated with these devices.

If the device profile exhibits at least one pattern (for example has the same make, model, version with a given set of settings and a given set of apps installed) then there may be a strong chance that this device will also experience the problem associated with the pattern. A remedy/solution/resolution may then be proactively sent to the mobile device to overcome the problem associated with the matched pattern.

In the context of the present disclosure, a pattern is a set of similar device profile elements exhibited by a large enough set of multiple device profiles. For example, if 15% of devices with the same make, model, OS and firmware version where App1 and App2 are installed are experiencing a crash, then this may be considered a pattern. The threshold for such a pattern may be a percentage of devices or an absolute number.

For devices exhibiting the pattern and experiencing the crash a remedy may be sent to fix the problem e.g. uninstall App1 or uninstall App2 so that the pattern that is causing the problem (crash) can be broken. The customers who have the other 85% of the devices may be informed not to install App1 and App2 at the same time or else they will experience the same problem as the 15% that are currently exhibiting the pattern.

Exemplary channels of communication that may be employed for communicating resolutions or warnings to a customer may include but are not limited to a voice call e.g. a phone call, e-mail exchange, device native notification methods like the Apple Push Notification Service (APNS), or the Google Cloud Messaging for Android (GCM), a chat session, message boards, forums, etc.

The fix or the recommendation may be routed to a customer's voice call, or may be routed to a chat session, or other source or form of communication dictated by a customer preferences. The nature of the fix or recommendation may also dictate the best form of communication or channel for an automated fix.

The proactive fix may also follow an unrelated problem report. In addition to the response to the original question asked by the customer, a remedy/solution/resolution may be proactively sent to the customer device regarding issues pertaining to the device (make/model/version) that are unrelated to the original question.

According to a first aspect of the invention, a method is provided for creating pattern-problem pairs for proactive diagnosis of device issues. A plurality of problem reports are received from problem devices, each device having parameters associated with a device profile. The problem reports are parsed to standardize and normalize terms. The parsed problem reports are analyzed to identify common problems in a set of such problem devices where there is a common set of parameters in a pattern. If the frequency of the problems in the set of devices exceeds a threshold, the parsed problem is associated with the pattern for future proactive diagnosis of a target device having the pattern, even without a problem report from the target device.

The parsing may use natural language processing.

Preferably, the parameters include at least one of make, model, OS and firmware version. The parameters may also include installed apps.

The method may also include storing problems with associated patterns in pattern-problem pairs. Each pattern-problem pair may be stored with an associated corrective action. Preferably, wherein the corrective action is in a format to be automatically provisioned to the target device.

For example, the problem may be a device crash. The pattern may be a certain combination of apps installed on problem devices. The pattern may be a certain combination of apps installed on problem devices having a common make, model and version.

According to a second aspect of the invention, a method is provided for proactively diagnosing a potential problem on a device. A device profile is received from a target device, having a plurality of parameters. The parameters are compared against a database of patterns of parameters associated with known problems. The database had previously been created from problem reports and patterns of parameters from other devices. If there is at least a partial pattern match with parameters of the target device, a corrective action is automatically triggered on the target device for the problem associated with that matching pattern, in the absence of a problem report from the target device with respect to that problem.

The corrective action may be a notification sent to the user of the target device. The notification may be a warning not to install an app on the target device. The corrective action may be to automatically adjust a setting on the target device. The corrective action may be to reset or restart the target device. The corrective action may be to provide a fix or make a fix available to a user of the target device.

Receiving a device profile may occur periodically, or the device profile may be retrieved from a cache. The device profile may be received or retrieved on receipt of a request for self-care, such as on receipt of a problem report for the target device on an unrelated problem.

A partial pattern match may be stored until a later time when conditions create a full pattern match, in which case the corrective action may only be triggered when the full pattern match occurs.

A partial pattern match may be stored until a later time when a full pattern match is imminent, in which case the corrective action (e.g. a warning or blocking of a requested action) may only be triggered when the full pattern match is imminent. For example, the pattern match may be imminent due to a request or attempt to download or install a new app.

Devices that can benefit from the system of the invention may include but are not limited to a computer, a server, network appliance, set-top box, SmartTV, embedded device, computer expansion module, personal computer, laptop, tablet computer, personal data assistant, game device, e-reader, a mobile device for example a Smartphone, any appliances having interne or wireless connectivity and onboard automotive devices such as navigational and entertainment systems.

### BRIEF DESCRIPTION OF THE FIGURES

FIG. 1 is a flow diagram illustrating a basic process for proactive self-care using pattern-problem pairs.

FIG. 2 is a network diagram illustrating one possible architecture of the profile and pattern-problem analytics.

FIG. 3 is a flow diagram illustrating a basic process for accumulating a database of pattern-problem pairs.

FIG. 4 is a conceptual diagram of an exemplary pattern-problem pair.

FIG. 5 is an exemplary flow diagram of handling full and partial pattern matches.

FIG. 6 is a flow diagram of proactively sending a fix in response to an unrelated device question or problem report.

### DETAILED DESCRIPTION

Before embodiments of the invention are explained in detail, it is to be understood that the invention is not limited in its application to the details of the examples set forth in the following descriptions or illustrated drawings. It will be appreciated that numerous specific details are set forth in order to provide a thorough understanding of the exemplary embodiments described herein. However, it will be understood that the embodiments described herein may be practiced without these specific details. In other instances, well-known methods, procedures and components have not been described in detail so as not to obscure the embodiments described herein.

Furthermore, this description is not to be considered as limiting the scope of the embodiments described herein in any way, but rather as merely describing the implementation of the various embodiments described herein. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation of the invention.

It should also be understood that many components and items are illustrated and described as if they were hardware elements. However, it will be understood that, in at least one embodiment, the components comprised in the method and tool are actually implemented in software.

The present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviours that other programming languages might perform during compilation. JavaScript, PHP, Perl, Python and Ruby are examples of dynamic languages.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), and at least one communication interface. A computing device may include a memory for storing a control program and data, and a processor (CPU) for executing the control program and for managing the data, which includes user data resident in the memory and includes buffered content. The computing device may be coupled to a video display such as a television, monitor, or other type of visual display while other devices may have it incorporated in them (iPad, iPhone etc.). An application or an app other simulation may be stored on a storage media such as a DVD, a CD, flash memory, USB memory or other type of memory media or it may be downloaded from the internet. The storage media can be coupled with the computing device where it is read and program instructions stored on the storage media are executed and a user interface is presented to a user. For example and without limitation, the programmable computers may be a server, network appliance, set-top box, SmartTV, embedded device, computer expansion module, personal computer, laptop, tablet computer, personal data assistant, game device, e-reader, or mobile device for example a Smartphone. Other devices include appliances having internet or wireless connectivity and onboard automotive devices such as navigational and entertainment systems.

The program code may execute entirely on a mobile device or partly on the mobile device as a stand-alone software package; partly on the mobile device and partly on a remote computer or entirely on the remote computer or server. In the latter scenario, the remote computer may be connected to the mobile device through any type of network, including a local area network (LAN) or a wide area network (WAN), or the connection may be made to the internet through a mobile operator network (e.g. a cellular network). The code is specialized to execute functions described herein which enable a smoother and more efficient technological process.

The system has been developed because the sheer volume of inquiries and communications related to modern devices outstrips all human ability to address each one. In this case, pattern-problem pairs are used as an analytical tool that may be implemented to allow for proactive problem resolution with fully-automated handling to avoid/reduce the need for CSR involvement.

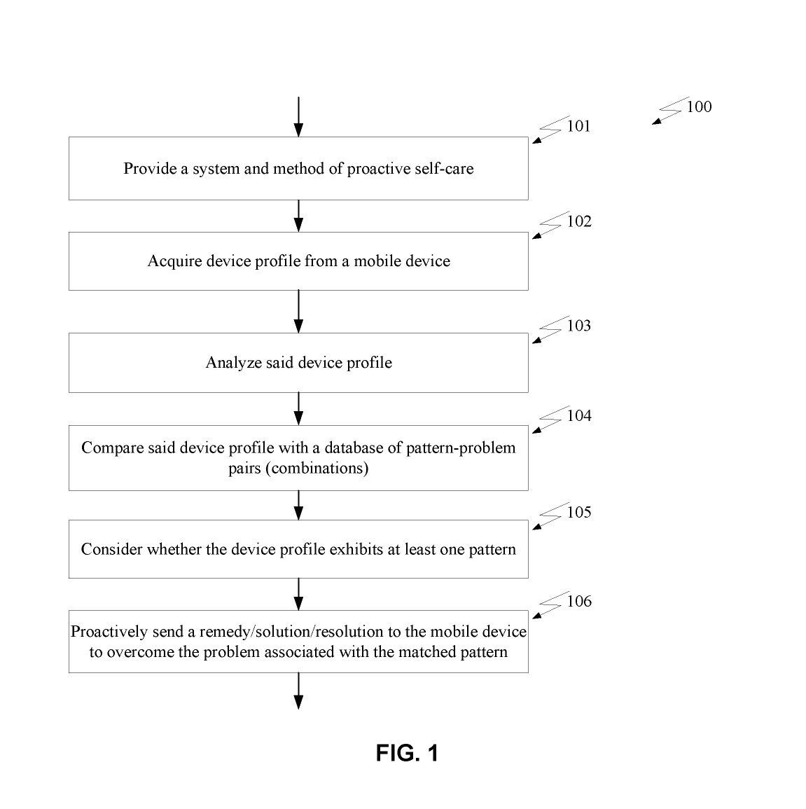

FIG. 1 shows the process of proactively sending solutions to remedies before a user experiences the problem 100. A system and method is provided for proactive self-care 101 for electronic devices e.g. mobile devices like Smartphones.

Solutions to unresolved device issues can be sent directly to consumers even before a consumer may have experienced the issue so that the problem can be proactively overcome thus avoiding having to call the customer service department.

The terms customer, consumer and user have been used interchangeably and imply a person using a device or service provided by either a manufacturer or a service provider.

A device profile is acquired from a mobile device 102. In certain embodiments, an app may be used for acquisition of device profile data from the device by querying its settings.

Information that can be gathered from the device may include but is not limited to: the device make, model and manufacture information; applications (commonly referred to as “apps”) installed on the device; apps and processing running on the device; certificates on the device; user profile information; the character of any passcode used to authenticate a user (e.g. whether a password/passcode is used and the relative strength of that password, such as the number of characters); operating system of the device; information regarding whether the device operating system has been tampered with by the user (e.g. an iOS device has been jailbroken, or a Google Android device has been rooted); and settings for SMTP servers, Gateway IP addresses, APN, Build Versions, list of malicious apps, etc. and the data usage e.g. the amount of MB or GB used for a given billing period, the amount data used while roaming, or the relative amount compared to a data plan used by the user-which may be useful for monitoring or controlling costs when paying for data usage. The app may also take into account additional information e.g. previous problems encountered, text added by the customer for a complaint, question, or comment; call history to customer service department and the like.

A device profile that the app gathers may include the following: device make, device model, OS version, language, operator, location etc. On a given device, these may be, for example:
Device Make=Motorola
Device Model=Nexus 6
Operating System=Android 5.0.1 Lollipop
Language=English
Operator=AT&T
Location=San Francisco, Calif. USA

The list of apps installed and running on the mobile device may be acquired. For example, the list of apps installed and running on a given mobile device may include the following:
Youtube
Fitbit
Google Play Store
Nest
Candycrush
AlphaBetty Saga
LG TV Remote
Netflix
Starbucks

The device parameter information may be gathered from the device in real time. The device parameter information may also be gathered from information cached earlier.

The device profile is then analyzed 103. The device profile may be analyzed with related data gathered from the device. A rules engine may be used for analyzing the device profile. The rules engine may be hosted on a remote server and the device may connect to the remote server over a network e.g. over internet.

A rules engine is a software system that executes one or more rules in a runtime environment. A rule engine may be viewed as a sophisticated if/then statement interpreter. The if/then statements that are interpreted are called rules. The app may have the agent and the rules engine embedded in it while also providing a user interface using which a user may be able to add text e.g. ask a question. In another embodiment the rules engine and the rules may be on a remote server. One such rules engine for customer care is described and taught in U.S. patent application Ser. No. 13/968,631, filed Aug. 16, 2013, which is incorporated herein by reference.

A rule consists of some number of conditions and some number of actions. Generally the rules are written in a high-level business language that relates to the domain, storing the rules in the repository. The Rules Repository may also include proto-rules i.e. rules not completely validated yet for implementation. A database may be used as the preferred and exemplary embodiment to store the rules. In another embodiment the rules may be stored in a list, in a table or other method that may be suitable for so doing.

A rule can generally be represented as IF CONDITION(S) THEN RECOMMENDATION(S)/FIX(ES). It can consist of one or more conditions (the “IF”). One or more conditions can be grouped together by “and” and “or” and the order of operations can be further defined using brackets. In each condition, there could be a device attribute, a conditional operator (=, >, <, !=, exists, not exists) and then a text box in which to enter static text, numeric, date-time value or another device attribute. These conditions can then be rearranged, grouped, and joined together to form a bigger condition.

A rule should also contain a recommendation or a fix (the “THEN”). When saved, the rules will follow the Rules Lifecycle (status including but not limited to DRAFT, PENDING, VALIDATION, REJECTED, VALIDATED (Nth), ACTIVE, INACTIVE) and only active rules may be disseminated to other sources. The scope of a rule can be system-wide, device-specific, model-specific, manufacturer-specific, operator-specific etc.

The device profile is then compared with a database of pattern-problem pairs (combinations) 104. In one embodiment the pattern-problem pairs (combinations) are derived by analyzing a large set of device profiles and the problems originating from and associated with these devices.

The system checks whether the device profile exhibits at least one pattern 105, for example has the same make, model, version with a given set of settings and a given set of apps installed.

If there is a match to the pattern, a remedy/solution/resolution can be sent to the mobile device to overcome the problem associated with the matched pattern 106. In one embodiment the remedy/solution/resolution may be sent in the preferred language of the consumer.

If a pattern-problem pair exists, and a device profile exhibits the pattern from the pattern-problem pair, then the system infers that there are strong chances that the device will also experience the problem associated with the pattern-problem pair.

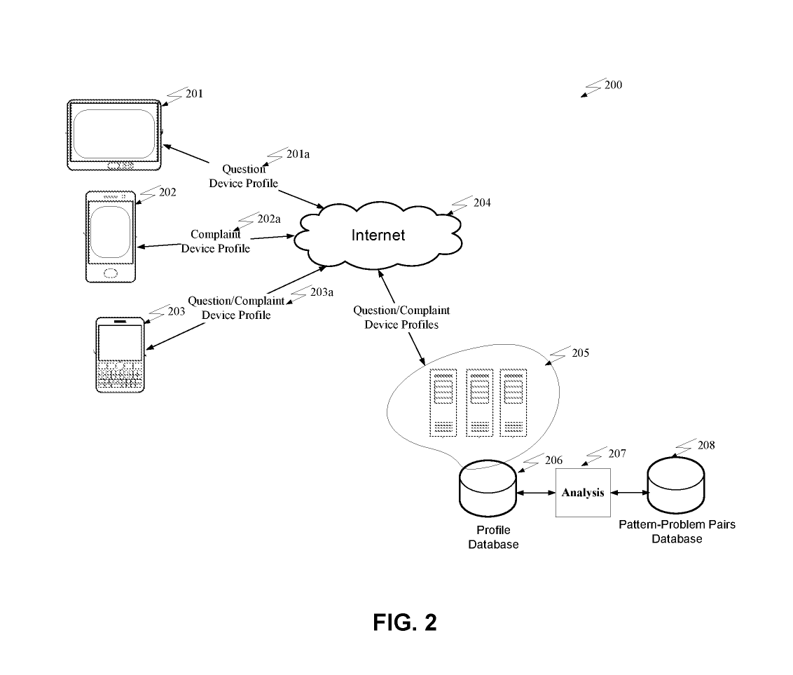

FIG. 2 shows a network view of the different entities (devices, servers, databases etc.) that interact according to one exemplary architecture of the system 200.

FIG. 2 shows multiple devices customers may be using to send comments, complaints or questions. Device profiles are extracted directly from these devices. Thus exemplary Device 201 sends Question and Device Profile 201a, while Device 202 sends Complaint and Device Profile 202a, and Device 203 sends Question/Complaint/Comment and Device Profile 203a. The customer communications (comments, complaints and questions) and the device profiles are transmitted over the internet 204 and received by the system servers.

The system may include one or more servers 205 that may host a profile database 206, analytics engine 207, a pattern-problem pair database 208 a rules engine and other modules necessary to carry the process described herein.

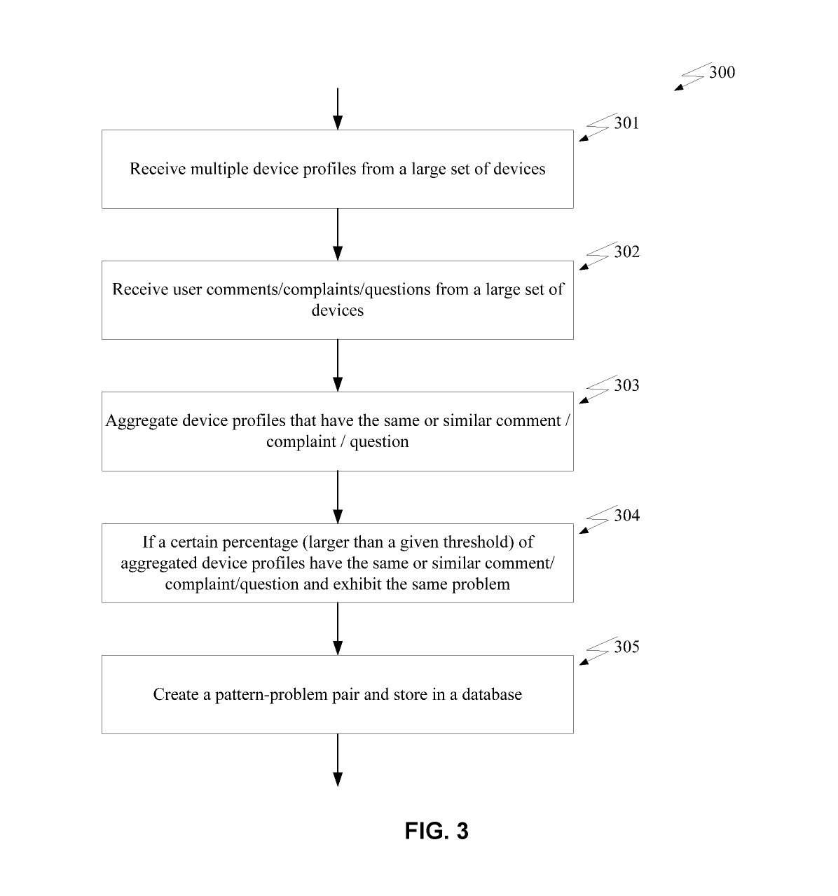

FIG. 3 shows the process of pattern-problem pair creation 300. Multiple device profiles are received from a large set of devices 301. These may be received at a server that is connected to the internet. The multiple device profiles may be extracted from a variety of mobile devices over a period of time on a periodic basis or these profiles may be extracted as part of another process.

User comments/complaints/questions are received from a large set of devices 302. The device profile and the comment/complaint/question from the device may be received at the same time. In other embodiments comments/complaints/questions are first received from a device, and as a result, instructions are sent to the app on the device to extract a device profile and send it to the server.

The device profiles that have the same or similar comment/complaint/question are aggregated 303.

In some embodiments when aggregating the device profiles and the comments/complaints/questions from multiple devices, the aggregation may use one or more languages utilizing Natural Language Processing (NLP) to associate same/similar comments/questions/complaints asked in different languages.

The system checks whether a certain percentage (larger than a given threshold) of aggregated device profiles have the same or similar comment/complaint/question and exhibit the same problem 304. For example 80% of aggregated device profiles may have the same or similar comment/complaint/question and exhibit the same problem. This may exceed a previously established 75% threshold for creating a pattern-problem pair.

A pattern-problem pair is then created and stored in a database 305. In one embodiment the pattern-problem pair database may be hosted on a remote server that is accessible over a network e.g. the Internet or a local area network so that it may be queried by various modules of the system.

The pattern-problem pairs (combinations) may be derived by analyzing a large set of device profiles and the problems originating from and associated with these devices.

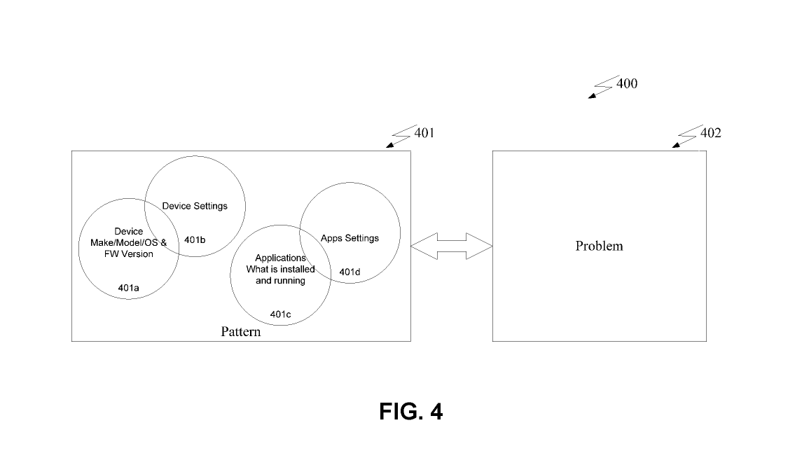

FIG. 4 shows an exemplary pattern-problem pair 400. The device profile pattern is represented by 401 while an associated problem is represented by 402. A pattern is a set of similar device profile elements exhibited by a large enough set of multiple device profiles.

The device profile pattern 401 has device make, model, OS and firmware versions 401a and the associated device settings 401b and applications (apps) that are installed and/or running on the device 401c and the app settings 401d.

FIG. 4 shows a device profile pattern and one problem associated with it. In other embodiments a pattern may have more than one problem associated with it.

If a pattern-problem pair exists, and a device profile exhibits the pattern from the pattern-problem pair, then there are strong chances that the device will also experience the problem associated with the pattern-problem pair.

In the context of the present disclosure a pattern is a set of similar device profile elements exhibited by a large enough set of multiple device profiles. For example if 15% of devices with the same make, model, OS and firmware version where App1 and App2 are installed are experiencing a crash, then there is a pattern.

For the devices that are exhibiting the pattern and experiencing the crash a remedy may be sent to fix the problem e.g. the resolution may be to uninstall App1 or uninstall App2 so that the pattern that is causing the problem (crash) can be broken. And the customers who have the other 85% of the devices may be informed not to install App1 and App2 at the same time or else they will experience the same problem as the 15% that are currently exhibiting the pattern.

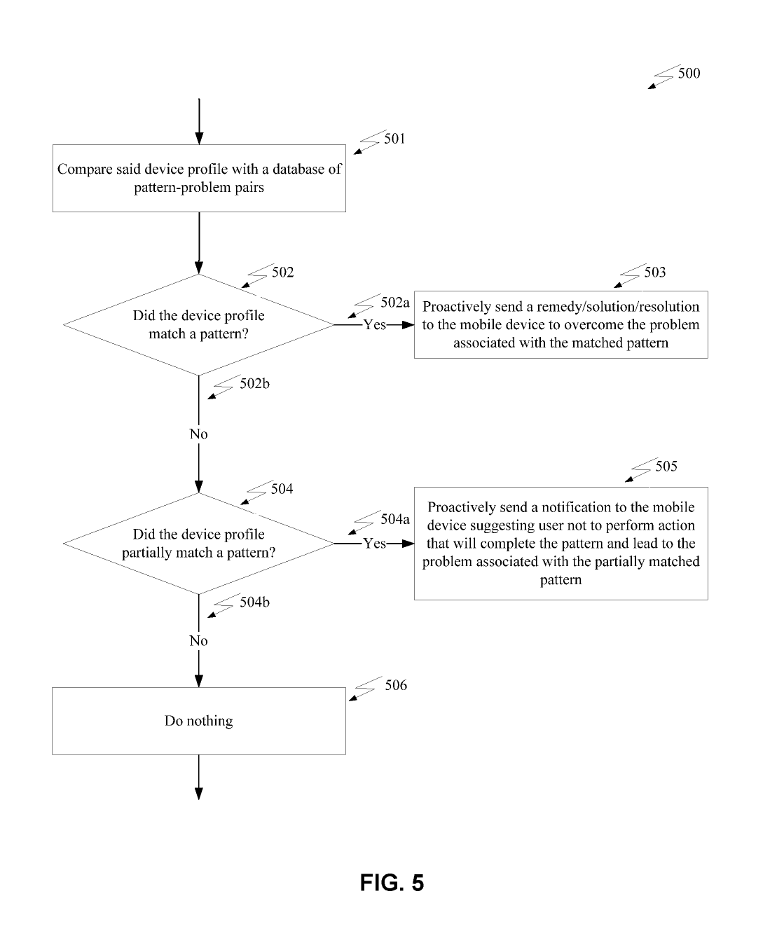

FIG. 5 shows a process of proactive self-care by analyzing a device profile and comparing it with the pattern-problem pair database 500.

The device profile is compared with a database of pattern-problem pairs 501. In one embodiment each time a pattern-problem pair is created it is saved to the database. In other embodiments the pattern-problem pairs may be stored in a file.

The system checks whether the device profile matched a pattern 502 in the pattern-problem pair database.

If Yes 502a, the device profile exhibits at least one pattern from the pattern-problem pair database, then the system proactively sends a remedy/solution/resolution to the mobile device to overcome the problem associated with the matched pattern 503.

Exemplary channels of communication that may be employed for communicating the resolutions or warnings to a customer may include but are not limited to a voice call e.g. a phone call, e-mail exchange, a chat session, message boards, forums, etc. device native notification methods like the Apple Push Notification Service (APNS), or the Google Cloud Messaging for Android (GCM), which is a service that helps developers send data from servers to their Android applications on Android devices.

The database storing the pattern-problem pairs may also store the solution(s) for overcoming the problem associated with a given pattern-problem pair. In other embodiments a separate database may be used for storing the remedy/solution/resolution to one or more problems.

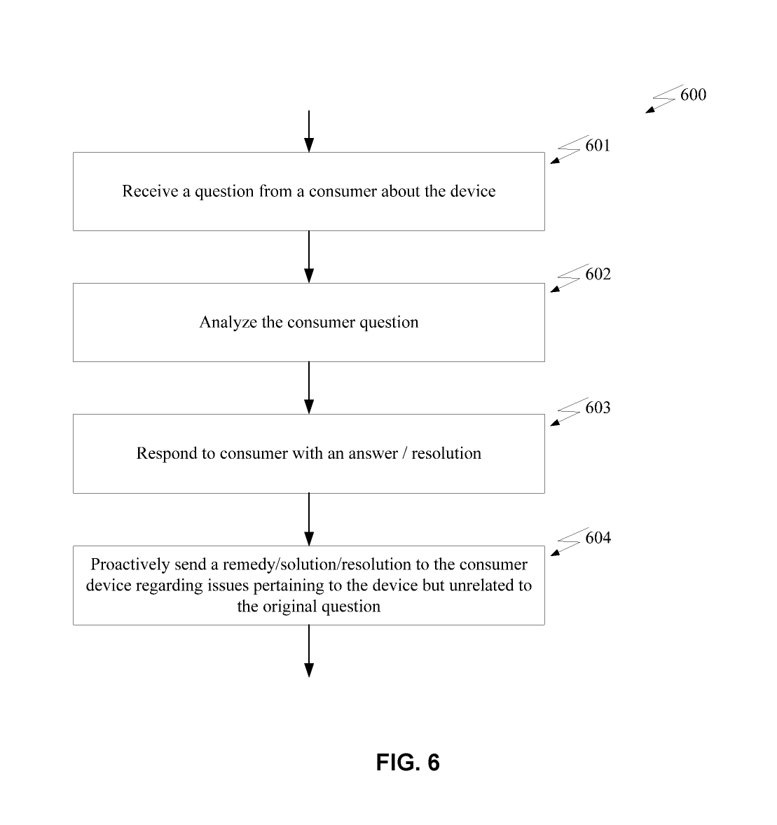

FIG. 6 shows the one embodiment 600. A question is received from a consumer about the device 601. For example, a consumer may be having problems with WiFi connectivity.

The consumer question is analyzed 602 using a rules engine or other automated mechanism.

An answer/resolution is provided to the consumer on the initial question 603. For example, an FAQ about WiFi connectivity may be sent, or the consumer may be asked to turn off and turn on WiFi etc.

A remedy/solution/resolution may also be proactively sent to the customer device regarding issues pertaining to the device but unrelated to the original question 604. For example, in addition to the response to the original question asked by the customer i.e. WiFi, a remedy/solution/resolution may also be proactively sent to the customer device regarding issues pertaining to the device (make/model/version) but unrelated to the original question. For example, a notification may be sent to the user about the fast battery drainage on the (make/model/version) of the device e.g. the battery life deteriorates if the device is left in very cold temperatures.

In one embodiment the remedy/solution/resolution to one or more problems may be to send a notification or a tutorial or an FAQ to the customer(s).

In another embodiment a remedy/solution may be suggested that requires customer engagement as a course of action e.g. uninstall a certain app, change some settings and restart the device.

In one embodiment a rules engine may be used for recommending and associating a remedy/solution/resolution to a device problem associated with the matched pattern-problem pair.

In another embodiment manual means may be used for finding a remedy/solution/resolution to a device problem associated with the matched pattern-problem pair.

In one embodiment a rule may embody the actual, required values for the different fields e.g. SMTP Server, Gateway IP addresses, APN, Build Versions, list of malicious apps, etc. The actual values may be seeded in a rule or could be obtained from another source either on the server or on the device. In one embodiment the execution of the rules allows for the comparison of the values found on the device with the values in a rule. If the two values i.e. the value of a field in the device and the value of the field in the rule are NOT equal it is concluded that the device is in need of a fix and the value of the field in the device may be replaced with the value of field in the rule.

A remedy or solution may be to replace the value of a field from a rule to the value of a field in the device. The rules may also preferably use reference values, standard values, target values, a range of values etc.

Alternatively the user may be able to edit, add, delete, and modify etc. the values required in a field.

In another embodiment information may be presented e.g. a notification or a tutorial or an FAQ; alternatively a remedy may be suggested that requires user engagement as a course of action e.g. uninstalling certain apps and restarting the device.

The system checks whether the device profile partially matched a pattern 504. A partial pattern is a pattern that lacks one or more elements of a pattern that is associated with a problem. Thus a partial pattern is very similar to the pattern in an established pattern-problem pair.

If Yes 504a, the device profile matches at least one pattern partially 504a, then the system may proactively send a notification to the mobile device suggesting the user not perform an action that will complete the pattern and lead to the problem associated with the partially matched pattern 505.

If No 504b, the device profile does not exhibit at least one partial pattern, the system may do nothing 506 and end process. Alternatively, in another embodiment the system may fine tune the performance of the device for better utilization of existing computing power and services being consumed by the device.

In one embodiment the fix may be automatically applied. In another embodiment a solution may be provided where the user may be able to edit, add, delete, and modify etc. the values required in a field.

If no resolution or remedy is available, the user may be prompted to escalate the issue. This process may be user initiated or may begin automatically depending on a number of factors including user preferences, settings etc.

It should be understood that although the term application has been used as an example in this disclosure but in essence the term may also imply to any other piece of software code where the embodiments of the invention are incorporated. The software application can be implemented in a standalone configuration or in combination with other software programs and is not limited to any particular operating system or programming paradigm described here.

Several exemplary embodiments/implementations of the invention have been included in this disclosure. The application is not limited to the cited examples, but the intent is to cover all such areas that may be benefit from this invention.

The examples noted here are for illustrative purposes only and may be extended to other implementation embodiments. While several embodiments are described, there is no intent to limit the disclosure to the embodiment(s) disclosed herein. On the contrary, the intent is to cover all practical alternatives, modifications, and equivalents.

What is claimed is:

1. A method of creating pattern-problem pairs for proactive diagnosis of device issues, comprising:
receiving a plurality of problem reports of problem devices, each said device having parameters associated with a device profile;
parsing the problem reports to standardize and normalize terms;
analyzing the parsed problem reports to identify common problems in a set of such problem devices where there is a common set of parameters in a pattern; and
if the frequency of the problems in the set of devices exceeds a threshold, associating the parsed problem with the pattern for future proactive diagnosis of a target device having the pattern, even without a problem report from the target device.

2. The method of claim 1, wherein the parsing uses natural language processing.

3. The method of claim 1, wherein the parameters include at least one of make, model, OS and firmware version.

4. The method of claim 1, wherein the parameters include installed apps.

5. The method of claim 1, further comprising storing problems with associated patterns in pattern-problem pairs.

6. The method of claim 5, further comprising storing each pattern-problem pair with an associated corrective action.

7. The method of claim 6, wherein the corrective action is in a format to be automatically provisioned to the target device.

8. The method of claim 1, wherein the problem is a device crash.

9. The method of claim 8, wherein the pattern is a combination of apps installed on problem devices.

10. The method of claim 9, wherein the pattern is a combination of apps installed on problem devices having a common make, model and version.

11. A method of proactively diagnosing a potential problem on a device, comprising:
receiving a device profile of a target device, the device profile having a plurality of parameters;
comparing the parameters against a database of patterns of parameters associated with known problems, the database having been created from problem reports and patterns of parameters from other devices; and
if there is at least a partial pattern match with parameters of the target device, automatically triggering a corrective action on the target device for the problem associated with that matching pattern, in the absence of a problem report from the target device with respect to that problem.

12. The method of claim 11, wherein the corrective action is a notification sent to the user of the target device.

13. The method of claim 12, wherein the notification is a warning not to install an app on the target device.

14. The method of claim 11, wherein the corrective action is to automatically adjust a setting on the target device.

15. The method of claim 11, wherein the corrective action is to reset or restart the target device.

16. The method of claim 11, wherein the corrective action is providing a fix or making a fix available to a user of the target device.

17. The method of claim 11, wherein receiving a device profile occurs periodically.

18. The method of claim 11, wherein receiving a device profile occurs on receipt of a request for self-care.

19. The method of claim 11, wherein receiving a device profile occurs on receipt of a problem report for the target device on an unrelated problem.

20. The method of claim 11, wherein the partial pattern match is stored until a later time when conditions create a full pattern match, and wherein the corrective action is only triggered when the full pattern match occurs.

21. The method of claim 11, wherein the partial pattern match is stored until a later time when a full pattern match is imminent, and wherein the corrective action is only triggered when the full pattern match is imminent.

22. The method of claim 21, wherein the pattern match is imminent due to a request or attempt to download or install a new app.
